(19) United States
(12) Patent Application Publication
(10) Pub. No.: US 2017/0237623 A1
(43) Pub. Date: Aug. 17, 2017

(54) Methods and apparatus for unified integration and processing of a variety of information sensors and systems

(71) Applicants: Kilton Patrick Hopkins, Mountain View, CA (US); Param Singh, Palo Alto, CA (US); Michael Gurevich, Walnut Creek, CA (US)

(72) Inventors: Kilton Patrick Hopkins, Mountain View, CA (US); Param Singh, Palo Alto, CA (US); Michael Gurevich, Walnut Creek, CA (US)

(21) Appl. No.: 15/044,102

(22) Filed: Feb. 15, 2016

(51) Int. Cl. H04L 12/24; H04L 12/26; H04L 29/08

(52) U.S. Cl. CPC H04L 41/12; H04L 67/10; H04L 43/045

(57) ABSTRACT

An embodiment of a method for implementing an information processing system with numerous and varied information sources in a way that dramatically reduces the challenge of implementing such a system. A preferred embodiment contains connectors to external elements (114). Message canonicalizers (115) and message de-canonicalizers (116) allow any number of external elements to connect as both information sources and sinks. Information moves through a track (117), which is governed by the track information structure. Any number of processing elements (119) can be added to the track and are mapped to the track information structure. A track information store (120) is associated with the track and parallels the track information structure.

### CROSS-REFERENCE TO RELATED APPLICATIONS

This application claims the benefit of provisional patent application Ser. No. 62/116,904 filed 2015 Feb. 16 by the present inventor.

### FEDERALLY SPONSORED RESEARCH

Not Applicable

### SEQUENCE LISTING OR PROGRAM

Not Applicable

### BACKGROUND OF THE INVENTION

Users are buying Internet of Things (IoT) sensors and discovering that each of the purchases is a closed system, each with its own mobile application and a paid subscription to access their own data in the cloud. This is true for most IoT solutions on Kickstarter, at accelerators, or from funded startup projects. The enterprise, when attempting to make a commercial deployment of the IoT, is experiencing a similar but more entrenched set of problems, and with a higher value at stake.

There are commercial hubs of IoT that are available at Lowe's or Best Buy. Iris is such a system available at Lowe's retail stores. It provides an IoT hub to which a select number of sensors can connect automatically.

The deficiency of this system (and similar systems) is that it is optimized for the home market and does not provide the features and functionality needed for commercial deployments by enterprises, building complexes, airports, and smart cities. A solution for these environments might involve several, currently missing, functional pieces including: high end processing boards (vs. microcontroller boards used in home systems), a completely open platform capable to connect to any sensor, integration with an enterprise backbone systems, including connection to legacy systems, and support of networks and protocols not found in home hubs. The differences are so significant that it may call for a different architecture on both the hardware and the processing method side.

This relates to the creation of information processing systems and information applications which make use of multiple information sources and information systems. The emerging IoT necessitates the creation of such an uber-system of systems. Sensors commonly use different hardware and coding formats, protocols, networks, and are connected through vertical, proprietary systems. Users commonly have go through a cumbersome process to authenticate each sensor, often having to download a separate application and subscribe to different backend services. Even sensor-hubs commonly only integrate a handful of sensor streams and connect to their own proprietary backend systems. Developers commonly have to create-from-scratch or heavily modify sensor algorithms for use in their vertical applications. The emergence of lower power, wider area networks with their own protocols and authentication makes this problem that much more complex. On the business side, enterprises are reluctant to setup vertical applications, pay for each service subscription, and manage the cumbersome operations and billing related to these services.

There are various types of sensors, each with the ability to collect their specific type of information and with unique properties based on the nature of the sensor. For instance, a temperature sensor can detect a change in temperature and report it in a specific unit format (Celsius or Fahrenheit or Kelvin, etc.). Different sensors may report temperature data in any of these formats and in different increments, making it difficult to standardize temperature data. This problem is further exacerbated across the full range of sensors, which include: proximity, presence, motion, acoustic, sound, vibration, microphone, air, fuel, chemical, CO2, olfactometer, electric, magnetic, moisture, humidity, hydrometer, water quality, rain gauge, snow gauge, tide, soil moisture, fish counter, flow, fluid velocity, air flow, gas meter, water meter, ionization radiation, subatomic particle Geiger, particle navigation, compass, accelerometer, air speed, slit meter, depth gauge, gyroscope, turn radius, vibration, position, angle, displacement, distance, speed, acceleration, free-fall, laser rangefinder, photoelectric, rate, tilt, thickness, photoelectric, optical, light, imaging, photon, infrared, flame, transition-edge, GPS position, pressure, barometer, oscillation, tactile sensor, force, density, level, hydrometer, load, load-strain, torque, thermal, heat, electro-chemical, flame, exhaust, infrared thermometer, bio-sensors, glucose, heart-rate, electromechanical film, body printed, tattoo sensors, and other emerging sensor hardware and sensor formats.

These sensors transmit the information that they are collecting over a broad range of networks. Some of these networks are based on unlicensed spectrum (no ‘spectrum’ licensing fees are required by the FCC) and licensed-Spectrum, including: TV white space and cellular spectrum bands. Various parts of the radio spectrum are reserved for different uses, including: Industrial Scientific Mechanical (ISM), Ultra Narrow Band (UNB 902-928 Mhz), TV spectrum, satellite, and Cellular.

The sensor data is communicated over various types of protocols including ZWave, Zigbee, HTTP (over TCP/IP), MQTT, COAP, and various other proprietary and open protocols. Each of these protocols is optimized for particular uses, such as: ZWave for home automation, Zigbee for mesh networking, or MQTT for asynchronous communication (vs. HTTP where each message waits in a queue).

User names and passwords remain the dominant means of authenticating consumers and users in the enterprise, despite the availability of other more secure and private mechanisms. Two-factor authentication provides multiple ways to verify the user's identity and profile. Single use token exchange between a user's profile (say with a smartphone) and a device is another more secure mechanism.

For IoT sensor networks a common method of authentication is via user names and passwords entered into applications for each use. Consumers typically have to download a unique app for each sensor or sensor hub.

Developers of IoT solutions typically use a different development platform or development stack for each sensor network or hub. This also means that machine-learning algorithms are specific to each development platform. The usage of open source development environments such as Eclipse IoT technologies (Paho, etc.) remains a small fraction of the IoT uses. Java SE and even new Java ME binaries are too large and too power hungry for most IoT sensors where longer battery life is at a premium.

IoT information systems typically have one or more enterprise, machine to machine (M2M), or cloud backends. Technology vendors have been using a variety of technologies (protocols, networks, etc.) to deliver custom and often-proprietary solutions to the specific features of various industry verticals (Oil and Gas, Utilities, Industrial, etc.). The variety of possible backends increases the difficulty of creating complete information systems because there is no single standard output that can be delivered to all backends. The increased complexity is often overcome by custom development efforts for each included backend.

### BRIEF SUMMARY OF THE INVENTION

The challenge of implementing information processing platforms that involve a multitude of information sources is very difficult. Platforms dealing with the IoT frequently have a great number of information sources, with those sources delivering a variety of information types at a variety of rates and quantities.

A well-known approach that is based on Complex Event Processing (CEP) methods and platforms results in a level of platform complexity that is very difficult to structure and even more difficult to maintain. The CEP architecture allows organizing and processing a multitude of information sources as event streams, but CEP is not suitable for the IoT without other supporting means because its main focus is on producing conclusions about whether or not a significant event has occurred. CEP becomes excessively complicated to be used with the enterprise-grade IoT, which requires combining a great multitude of IoT sensors with a vast amount of corporate data, and CEP does not assist in the structuring and programming of such a system.

Another well-known method that is based on the Simple Network Management Protocol (SNMP) model provides the ability to structure a large number of varied network information sources, but its ability to embrace IoT is limited, because SNMP architecture pertains to just managing network gear using its rigid Management Information Base (MIB) as implemented by the network gear manufacturers. Hence, while SNMP provides the notion of a MIB, it is not suitable for the IoT because it does not allow for flexible structuring of the information.

The invention is a method and a platform for connecting and integrating a limitless variety of information sources, processing operations, and information destinations in a way that eliminates the need for any of them to be constructed or altered specifically to interconnect directly with the others. The platform has components that manage connectivity between external elements and the system. It might manage security and authorization throughout various embodiments of itself and with regard to external elements. It might create reliable pathways for external elements to communicate with the appropriate software. It might provide a secure zone for software to operate with flexibility of language, operating system, and resources for each piece of software. In another embodiment the platform might manage the routing and movement of information in a way that allows for a vast number of possible configurations and workflows without the need for altering the components. It might provide tools for configuring that routing and information movement that are easy to use. It may provide a limitless number of templates and incorporate software standards that make it much easier for any person to create interconnectable components. Another embodiment of the platform manages the time differential between external elements and the deployed embodiment itself, between external elements and other external elements, and between distributed components of an embodiment of the platform so that interoperability can be achieved without the need to calculate time differences within each component. It provides a method of attaching components to a particular time period or other piece of information, which results in increased information details and processing activity for the desired point of focus. The various embodiments of the platform may include a store that allows platform users to discover, purchase, and implement additional processing easily. It might provide metering and monitoring of the platform's health and information flows within and to and from the platform. The platform might also include a marketplace for offering information outputs for sale or use by the public or private parties. It might manage the connection and formatting needed to adapt information outputs to any external-system, enterprise backends, cloud architectures, or other information destinations.

### LIST OF FIGURES

FIG. 1: Functional overview of an embodiment of the invention which outlines how information enters from external elements, is processed, and exits to external systems.

FIG. 2: Detail view of external element inputs, connectivity management, and device and element management components.

FIG. 3: Detail view of a translation component that interfaces between external elements and internal formats, a continuous routing engine, and routing engine configuration.

FIG. 4: Detail view of movement of information between a routing engine and processing elements, processing element instances, configuration of processing element instances, and metering of information flows.

FIG. 5: Detail view of routing engine configuration, a storehouse of processing elements, and auditing and monitoring services.

FIG. 6: Detail view of a storehouse of processing elements and a storehouse of common information formats.

FIG. 7: Detail view of a marketplace for data stream outputs and information flow metering and monitoring.

FIG. 8: Illustration of the operations and workflow of an embodiment of the invention.

FIG. 9: Overview of one particularly beneficial embodiment of the invention.

FIG. 10: Table of some possible implementation configurations

### LIST OF ITEMS FOUND IN THE FIGURES

101 (a through d): Elements that are external to the platform, such as sensors, smart devices, full computing external-systems, and enterprise backends.
102: A layer of connection management functionality for external elements.
103: A layer of device management functionality regarding external elements.
104: A layer of translation between external element information formats and an internal common information message format.
105: A continuous information routing and movement engine.
106 (a through f): Information processing elements, including information manipulation, data processing, information validation, policy and rules processing, storage handling, and other activities.
107: A means for configuration and management of an information movement and routing engine.
108: A means for configuration of information processing elements on a per-instance basis.
109: A storehouse of information processing elements in a ready-to-utilize state along with information about all available processing elements.
110: A storehouse of internal common information message format variations, which are available to other components and to platform users.
111: Auditing and monitoring functionality.
112: A marketplace where outputs can be offered for sale and for public or private use by external parties and other platform users.
113: Information flow metering and monitoring functionality.
114: A connector to external elements and external-systems
115: A message canonicalizer
116: A message de-canonicalizer
117: A track
118: An information structure
119: A processing element
120: An information store
201: An operation block in which information is input
202: An operation block in which an assessment of connectivity allowance is performed
203: An operation block in which notification takes place
204: An operation block in which security an authorization assessments are performed
205: An operation block in which translation is performed
206: An operation block in which routing is assessed
207: An operation block in which routing continuation is determined
208: An operation block in which marketplace routing is determined
209: An operation block in which filtering and rules processing is determined
210: An operation block in which filtering and rules processing is applied
211: An operation block in which storage processing is determined
212: An operation block in which storage processing is applied
213: An operation block in which pattern recognition processing is determined
214: An operation block in which pattern recognition processing is applied
215: An operation block in which application store processing is determined
216: An operation block in which application store processing is applied
217: An operation block in which metering of information flow is performed
218: An operation block in which translation is performed
219: An operation block in which information is sent to external purchaser systems
220: An operation block in which translation is performed
221: An operation block in which information is sent to destination backends

### DETAILED DESCRIPTION OF THE INVENTION

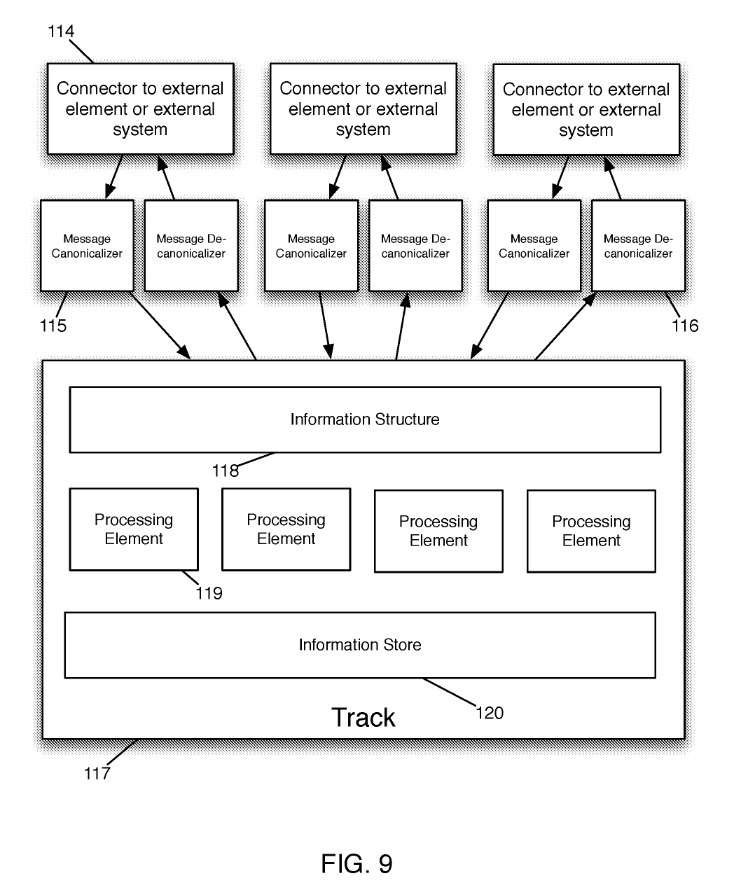

In one particularly beneficial embodiment of the invention, each external device or external-system is connected to the platform via a connector [FIG. 9, item 114]. Each connector passes its inbound information to a message canonicalizer [FIG. 9, item 115] and receives its outbound information from a message de-canonicalizer [FIG. 9, item 116]. Each message canonicalizer passes its message outputs to the track [FIG. 9, item 117]. The track contains a structure of information [FIG. 9, item 118] to which processing elements [FIG. 9, item 119] are mapped and an associated information store [FIG. 9, item 120] that parallels the information structure. The processing elements produce a multitude of outputs, which are deposited into the information store, and optionally sent as output messages. The output messages of the track are passed to message de-canonicalizers, which in turn pass their outbound information to connectors as previously described.

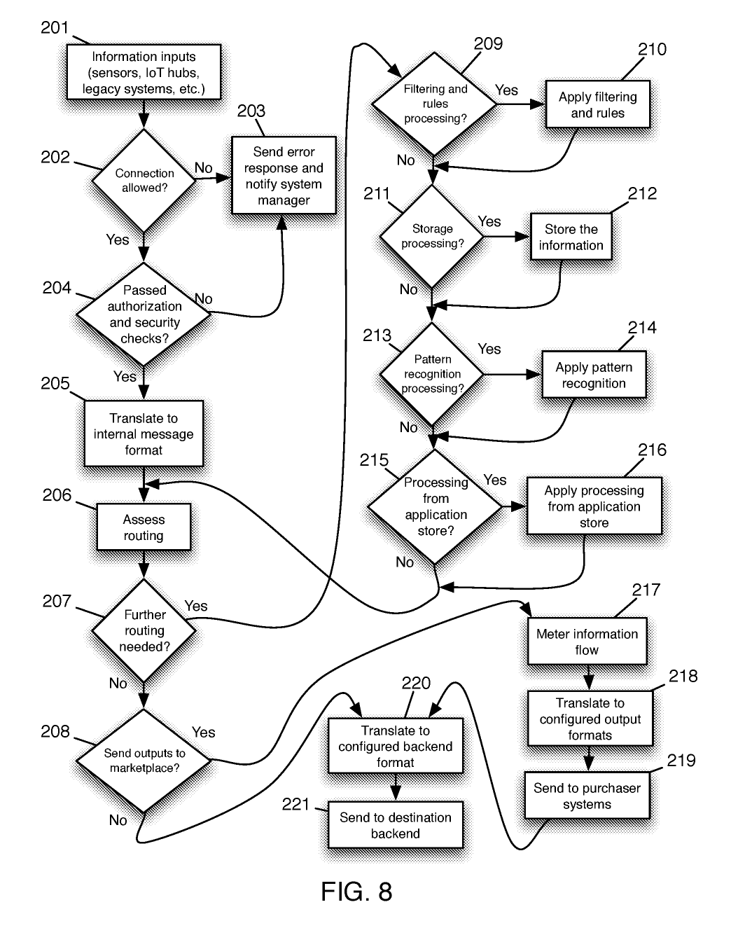

The operations of one embodiment of the invention are illustrated in FIG. 8 as a workflow diagram. Operations may begin at block 201 where information enters the embodiment [FIG. 8, item 201]. The information may come from a variety of sources, including sensors, IoT hubs and processing devices, and previously existing legacy-systems. As the information enters the embodiment, it is checked for connectivity allowance at block 202 [FIG. 8, item 202]. A sensor that does not have the proper connection configuration, for example, may have its information rejected because it is not to be allowed into the embodiment for processing. If such a rejection occurs, an error message may be sent back to the information originator and certain users of the embodiment may be notified about the rejection as illustrated in block 203 [FIG. 8, item 203]. If the information was allowed into the embodiment, it may then be checked for authorization and security requirements at block 204 [FIG. 8, item 204]. To continue the sensor example, a sensor may have the proper connection configuration, but it may lack the digital signature and cryptography needed to prove its identity and protect the information from public viewing. In this situation, an error message may also be sent back to the information originator and users are notified [FIG. 8, item 203]. If the information passed the authorization and security checks, it may be moved into translation processing at block 205 [FIG. 8, item 205]. Any information format may be allowed in the embodiment, but all information may be wrapped in a common message format that allows it to be moved from one component to another easily. At block 205 the information may be placed into a message format that complies with the internal message standard but also contains the appropriate descriptive information that fits with the underlying original information [FIG. 8, item 205]. This translation operation forms an information package that possesses attributes useful for interoperability with embodiment components [FIG. 8, item 205]. The now standardized information package may be moved to a routing engine. The routing engine uses configuration settings in block 206 to determine where the information package may be routed next [FIG. 8, item 206]. There are many different types of processing that can be applied to an information package. If further processing is indicated in block 207, the embodiment checks in block 209 to see if any information filtering or rules are to be applied [FIG. 8, items 207 and 209]. If so, a plugin for filtering and rules may be given the information package in block 210 and processing may occur [FIG. 8, item 210]. If not, the embodiment may skip that type of processing. The embodiment may check in block 211 to see if any storage processing may take place [FIG. 8, item 211]. If so, a storage handling plugin may be given the information package for processing in block 212 [FIG. 8, item 212]. If not, the embodiment may skip storage processing. The embodiment may check in block 213 to see if any pattern recognition processing might take place [FIG. 8, item 213]. If so, a pattern recognition plugin may be given the information package for processing in block 214 [FIG. 8, item 214]. If not, the embodiment may skip the pattern recognition processing. In block 215, the embodiment may check to see if any other processing using an item from a processing element plugin store might take place [FIG. 8, item 215]. If so, the chosen processing element plugin may be given the information package for processing in block 216 [FIG. 8, item 216]. If not, then the embodiment may skip this type of processing. The information package may be assessed again for routing by the routing engine [FIG. 8, item 207]. The embodiment determines if further processing may be required and can move the information package through further processing. The embodiment may release the information package to a marketplace gateway [FIG. 8, item 208]. If the information package is part of a platform output that is configured to be available in the marketplace as determined in block 208, then the information package may be prepared for output to marketplace recipients [FIG. 8, item 208]. One operation of that output preparation may be metering as shown in block 217 [FIG. 8, item 217]. The information package may be measured and recorded by a metering component in block 217 and then may be given to an output translation component in ash shown in block 218 [FIG. 8, items 217 and 218]. The information package may be translated into output formats requested by various marketplace recipients [FIG. 8, item 218]. The information in its possibly various forms may be sent out to marketplace recipients as shown in block 219 [Figure #8, item 219]. The information package in its non-translated form may be sent to a backend output translator in block 220 [FIG. 8, item 220]. The information package may also be sent here directly if it is not included in a platform output that is offered in the marketplace [FIG. 8, item 208]. The backend output translator may prepare the information package to be sent to destinations as shown in block 220 [FIG. 8, item 220]. The information package may be translated into formats specified in the backend output translator's configuration [FIG. 8, item 220]. Then the information, in its various output formats, may be sent out to backend destinations as shown in block 221 [FIG. 8, item 221].

The invention can be assembled and embodied in a variety of configurations using a mixture of hardware, platform plugins, external-systems, firmware, operating systems, technologies, and networks. One complete embodiment is comprised of a rack-mountable computer, a configurable network switch, a second computer located in a secure data center facility, a routing engine, a set of processing elements existing as plugins (e.g. to Linux containers), and a set of user interface screens for interacting with the embodiment. The configurable network switch is embedded in the same enclosure as the rack-mountable computer. The two items together form a physical unit that can be installed in standard network and data center racks. The unit requires a source of power in the form of a regular wall outlet and requires a standard high-speed Internet connection supplied via Category 5 or Category 6 network cable and a standard RJ-45 connector. The configurable network switch serves as the point of input connection for external elements. The switch is configured to channel each switch port or group of switch ports into a specific IP address and port on the rack-mountable computer. The rack-mountable computer is of a standard x86 processor configuration running the Linux operating system. The routing engine resides on the rack-mountable computer and operates continuously. It receives its configuration information from the data center computer and uses that information to configure the network switch. Each external element that is connected to the embodiment might be given an IP address and port to use for connecting to the embodiment. Those IP addresses and ports are mapped to Linux containers (implemented using Docker or similar container management products) hosted on the rack-mountable computer. A component of the routing engine known as an agent is included in each Linux container instance. It listens continuously for incoming data on the network and passes that data to external element driver installed in the Linux container. The external element driver receives the incoming network data passed to it by the agent. It communicates with the external elements connecting to it and manages their state, identity, security, activation, configuration, setup, and virtualization. The external element driver also translates the information coming from the external element into the appropriate common message format and passes to it to the routing engine agent. The agent knows how to pass the message to the master router in the routing engine. The master router knows where to send messages because it contains a map of origins and destinations. It has generated this map from the configuration information it received from the data center computer. The map can contain any number of origin and destination pairs, which means there are infinite possible routing operations. In addition, the master router can route to any number of destinations simultaneously. The routing is accomplished by moving network traffic from the originating IP address to all destination IP addresses found in the map. Java Message Services (JMS) may be used to handle the messaging infrastructure. All of the routing engine software may be constructed using the Java Enterprise Edition software development kit, code libraries, and tool set. All information routed through the embodiment may be a message type built on the JMS infrastructure. All of the destination points in the embodiment may also be Linux containers that have agents on them. This allows all destination points to receive and transmit messages in the same way, even though the processing plugins installed in the Linux container can be completely different for each container. The routing destinations and sequencing may be set up using a track management user interface. This interface is a Web screen that can be accessed by any modern Web browser software. When a routing destination is setup, the user can choose from any available processing plugins. The data center computer contains an inventory of available processing plugins and information about those plugins. Which plugins are available for selection by the user may depend upon the information type of the message at that point in the processing chain. One example is temperature information. A temperature sensor may have its own driver plugin, operating in a Linux container, that sends output messages of the type “temperature measurement”. In order to make use of this message output, it may be that only processing plugins that understand “temperature measurement” messages are allowed to be selected as next routing operations. A repository of information message formats may also be stored on the data center computer. The chosen processing plugins might be configured in the Web interface, as well. Configuration can be set uniquely for each processing element instance. The data center computer may store a copy of each processing plugin for installation on any rack-mountable computer as a unique instance. When the configuration of a routing operation is complete, it may result in a processing plugin being instantiated on the rack-mountable computer. A Linux container can be created and given an IP address and port configuration and a copy of the processing plugin can be installed and configured according to the routing operation configuration chosen by the user of the Web interface. The master router on the rack-mountable computer may update its map. Routing can occur for all information on the rack-mountable computer from plugin to plugin as configured by the user of the Web interface. This may occur on a continuous basis. When an plugin receives a message, what may happen inside the Linux container is that the processing plugin software receives a message through its agent plugin. It may then be given the opportunity to perform any processing it was designed to perform. When any processing has been completed, the processing plugin software may send the routing engine agent the resulting output message. It may be a message of any type and does not need to be the same message type as was received. The routing engine agent may deliver the output message to the master router. As functional operations continue, some information processing chains may eventually end up routing to an address that is outside of the rack-mountable computer. A virtual private network (VPN) connection to the data center computer can allow the rack-mountable computer to send it messages. A copy of the routing engine may also exist on the data center computer. The data center computer may also be running the Linux operating system on an x86 hardware platform. The data center computer might operate Linux containers that are common destinations for rack-mountable computers. A data stream marketplace container is one example. Although this container may operate the same as all other Linux containers on an embodiment of the platform, receiving JMS messages via an agent and optionally sending output messages after processing, it is described here because its internal operations may be unique when compared to standard information processing. The data stream marketplace container determines if incoming messages might be sent to subscribers outside of the embodiment. Messages destined for subscribers may be copied and the copies may be translated into the formats chosen by the subscribers. The data stream marketplace container may initiate the required connections to the subscriber destinations and deliver the formatted information. Subscribers may discover and subscribe to data streams using a Web user interface that we will call the marketplace UI. The marketplace UI may be operated on the data center computer along with the previously mentioned track management user interface. These user interfaces may be built upon the Play Framework for Java Web development. The marketplace UI might provide information about available data streams and allows users to subscribe to the streams. It might also allow the subscribers to configure the format and destination for their data stream. Payment processing may be handled by the marketplace UI, as well. Data used by the marketplace UI and the track management user Interface may be stored in a relational database on the data center computer. Another common Linux container that may be found on the data center computer is a backend adaptor container. The backend adaptor container operations might include the translation of information into a requested output format (based on the configuration chosen by a user via the track management user interface) and connection management to external-systems. The backend adaptor container may be an endpoint because this container does not send any information back out to the master router. The backend adaptor container may have connectivity to external-systems. That connectivity may include a VPN connection to the destination external-system. Otherwise it may use standard Internet connectivity out of the data center where the data center computer is housed. Metering and monitoring functionality in the embodiment may also operate as a Linux container. The metering and monitoring container may receive a copy of all messages routed on the embodiment without interfering with information traffic. The metering and monitoring container may have the ability to tell the master router to disable map options based upon quota violations or other judgments. It might do this with a special type of message that is sent to the routing engine itself.

The invention uses an open approach to connect to proprietary, legacy, machine to machine (M2M) sensors and new sensors, devices, and other external-systems. Instead of specifying specific methods of connecting to the embodiment, which can involve significant development or configuration effort on the part of the external element owner, the invention allows for original external elements to remain as they are. Connections to the embodiment may be made using a standard RJ-45 network connector. Transmissions may simply follow the Internet Protocol (IP) network standard over Ethernet. Connections may also be made using Universal Serial Bus (USB), Firewire, RS-232, SATA, PCI slot, Wi-Fi, Bluetooth, Bluetooth Low Energy, or any other standard computing interconnection method.

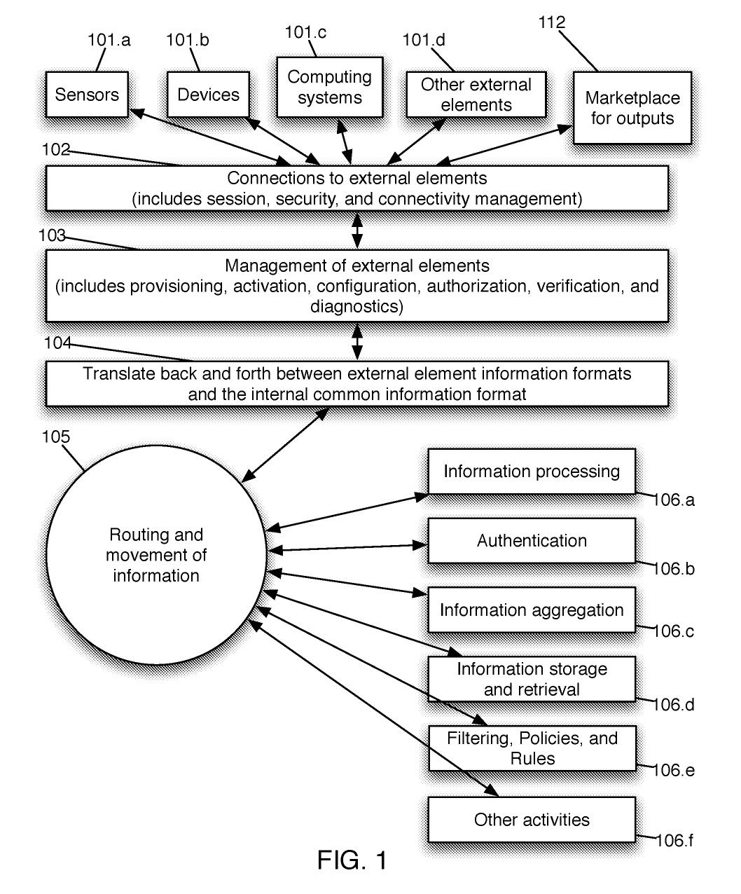

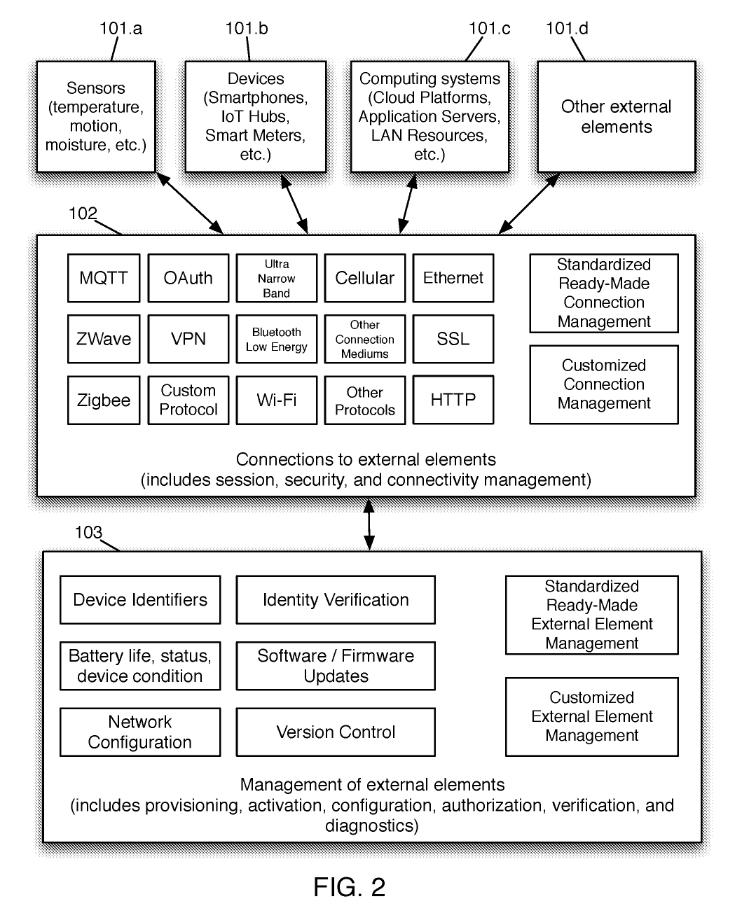

The invention can interact with all machines that possess the ability to interconnect with it [FIG. 1, item 101 and FIG. 2, item 101]. Some examples are sensors, smartphones, Linux servers, Microsoft Windows desktops, smart home hubs, Amazon Web Services clouds, Salesforce Force.com platform servers, IBM MQ units, ultra narrow band (UNB) radio transceivers, and standard Web servers. If any particular external element requires a connection type that is not natively available on the particular embodiment, an additional piece of hardware or software can be added to make that connection type available, provided that the additional hardware or software also offers a connection that matches one natively offered by the embodiment.

If an external element, such as an array of wireless sensors, involves a specialized piece of hardware or software, such as a radio base station, in order to function properly, then the point of connection with the embodiment can be made with the radio base station and not directly with the array of wireless sensors. In this way, the external element is allowed to exist in whatever state and arrangement is desired.

Connectivity to external elements may not only be a matter of physical wiring or wireless interconnects. A networking protocol may be necessary. The invention allows for any protocol to be used in communicating with external elements. Some example protocols are MQTT, Zigbee, ZWave, HTTP, and custom or proprietary protocols. One embodiment of the invention may be able to offer all protocols through the use of additional connection management plugins. If the external element involves a particular protocol, such as MQTT, then network connectivity using that protocol may be established using one of numerous approaches, including: a specialized piece of hardware or software that was designed to operate with the element can be used as the point of connection with the embodiment. A standard piece of hardware that handles the MQTT protocol may be used as the point of connection with the embodiment. A custom or customized piece of hardware that handles the MQTT protocol may be used as the point of connection with the embodiment. A standard piece of software that handles the MQTT protocol can be used as the point of connection with the embodiment. A custom or customized piece of software that handles the MQTT protocol can be used as the point of connection with the embodiment. The invention may allow for such a wide variety of options because it focuses on making space for additional plugins instead of focusing on directly speaking a finite set of protocols.

Session management and security management may be required for many connectivity situations. To accommodate a variety of situations, the invention allows for return communication, SSL/TLS or similar encryption and digital signature setup, and any configuration needed to facilitate these aspects of connection management. If the connection to an external element involves the OAuth 2.0 process, for example, then the connectivity management component may be configured to digitally sign message transmissions, accept callback requests, and execute the process fully in order to facilitate a successful connection.

By using Linux containers (including Docker containers or similar technologies) and virtual machines and other forms of virtualization, the invention may open space for the very wide variety of operating systems, code libraries, security implementations, programming languages, session management, and hardware interfaces that may be present in the marketplace [FIG. 1, item 102 and FIG. 2, item 102]. This is because each instance can exist in any form needed to operate properly without interfering with any other instances. Completely custom configuration may be made possible, with connection into the remaining pieces of the embodiment provided automatically.

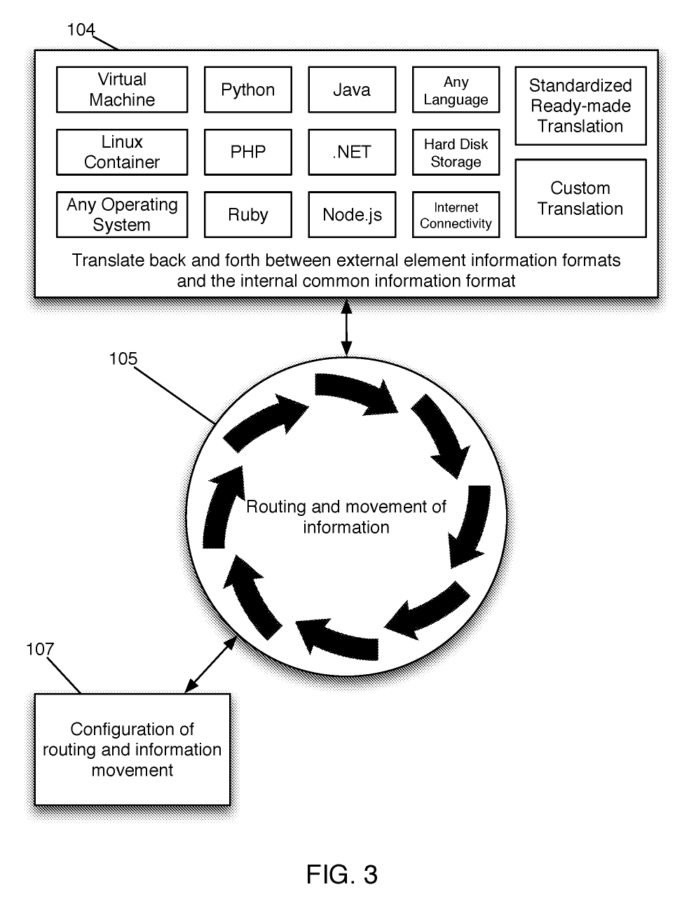

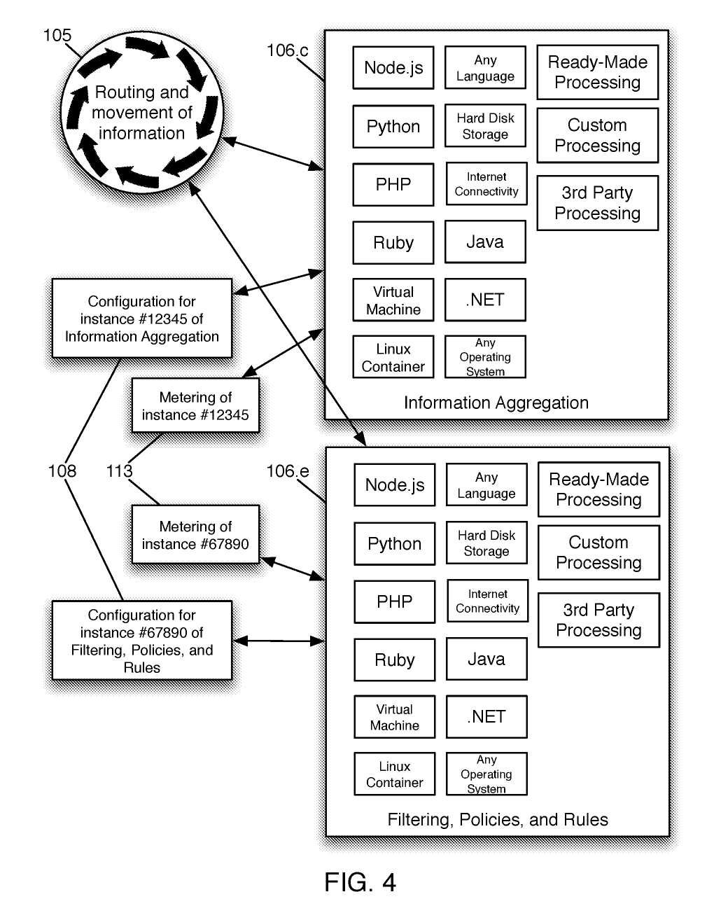

One embodiment of the invention may use virtualization and containerization for many of its components [FIG. 3, item 104 and FIG. 4, items 106.c and 106.e]. Linux containers, virtual machines, and any other standard virtualization technology can allow for high levels of flexibility, but when standing alone, the virtualization technologies do not allow for the creation of large-scale information processing systems. They allow for flexibility of programming language, software development platform, code library selection, programming framework, operating system, file systems, and more. In addition, security and reliability may be increased dramatically by using virtualization for the different components of the embodiment. If one component instance becomes unstable or begins consuming an undesirable quantity of resources, it may be repaired, restarted, shut down, reloaded, or otherwise handled without destabilizing or even interrupting the other components. The inner workings of any component can also be protected from unauthorized viewing, probing, reverse engineering, or other security concerns because the virtualization encapsulates each component.

Each virtualized instance may be given local resources that it can use as it sees fit. Random Access Memory (RAM), CPU, and long-term storage (hard disk space) may be allocated for each instance. One component may decide to store incoming images in the file system, for example, before executing image recognition processing on the files. Another component may never store anything in the file system but may consume 100% of its available RAM to perform real-time analysis of sensor data, for example.

Each virtualized instance may also be given an Internet connection. Connectivity to a Local Area Network (LAN) can be granted, as well, if desired. Using this, a component may make use of additional resources outside of the embodiment, look up key information stored elsewhere, perform security checks with outside parties, conduct authentication processing against a known identity verification resource, or perform any other operation desired.

Unless the virtualized component instances can communicate with each other, the benefits of the embodiment for large-scale application and solution development may not be fully realized. The embodiment may provide connectivity between all virtualized component instances without requiring the builders of the components to do any development work. The connectivity between virtualized instances may be accomplished using the routing of network traffic, the inclusion of an agent within each virtualized instance, the inclusion of resources libraries in each virtualized instance, providing a software development kit (SDK) to component builders, launching virtualized instances using central management software and passing information directly to each instance, or any other method that allows virtualized containers to communicate with other parts of the embodiment in a standard way. When the virtualized component instances are all connected together, sequences of processing may become possible. Information can move between virtualized components for processing, storage, replication, reduction, or any desired operation because all of the pieces are connected using the same methodology.

The management of external elements may be performed by modular components in the embodiment [FIG. 1, item 103 and FIG. 2, item 103]. External element management may be conducted via a connectivity management layer, allowing for the management hardware or software to communicate with the external elements effectively. External element management may consist of assigning identifiers to devices, setting network configuration on devices, activating and deactivating devices, checking battery life and status, verifying the identity of external elements, coordinating and issuing software or firmware updates, performing version controls to handle compatibility or minimum version requirements, and performing any task required for the external elements to interact with the embodiment properly.

It is likely that external element management may coordinate closely with connectivity management for the same external elements. It is possible for the two layers to coexist in the same virtualized instance, but this is not required.

External element management opens an opportunity for very beneficial abstraction. A variety of similar but unique devices, each having its own particular attributes, can be represented by a single abstract device definition. This is a form of device virtualization. For other functional components, component builders, or users of the embodiment, it may be much easier to build large-scale solutions when the external element management layer provides device virtualization. In this situation, temperature sensors from six different vendors can all be treated as if they were the same exact model of device, for example.

Large-scale technology solutions may benefit from having a standard framework for authentication. When some functionality might only be accessible to certain users or certain devices, authentication may be used to determine who is attempting to perform a certain function so access can be granted or denied. If authentication handling is different across components, enabling the use of only a single user identity or device identity may be difficult and sometimes not possible. This is because each component in the embodiment might perform authentication using its own method. Not all components may handle the single user identity the same way. If authentication is handled by all components in the same manner, the challenges may be dramatically reduced or even eliminated.

One embodiment of the invention may provide a standard framework for authentication by making that functionality an information-processing component similar to other processing components, such as image recognition, information aggregation, or information filtering [FIG. 1, item 106.b]. By processing authentication requests as a modular unit, the embodiment may provide a virtualized instance wherein authentication processing can be conducted as a separate application. The incoming authentication requests may arrive in a standard format, no matter the origin component requesting the authentication. The output from the authentication processing may only be in the standard format, and all requesting components may be able to make use of it equally.

Under this framework, it may be possible for many different external elements and components to all rely upon a single method of performing authentication processing, yet no one use of the embodiment might involve any specific type of authentication processing. That portion of the embodiment can be implemented in any way desired. This situation may allow for the integration of existing authentication methods, the construction of new ones, or any combination. Most importantly, it may prevent the volume of authentication processing challenges from increasing along with the number of external elements that are used with the embodiment.

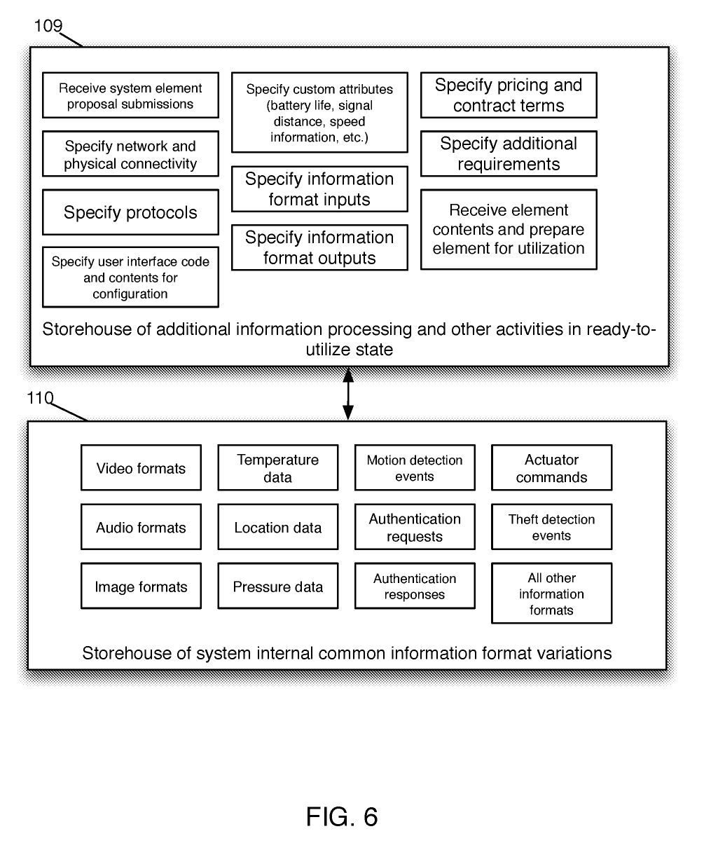

One embodiment of the invention may support various types of data streams generated by sensors and devices, including, but not limited to, heartbeat, streaming data, and streaming media. The embodiment may standardize the sensor and device data using an embodiment-wide information message format [FIG. 1, item 104 and FIG. 3, item 104 and FIG. 6, item 110]. There may be both programmatic and visual ways of mapping the incoming data streams into the embodiment-wide message format, which may then be treated as a consistent standard upon which a variety of programmatic actions can be performed, including time-correlation, calculations, merging data streams, and innumerable other types of processing.

For instance, there may be 3 temperature sensors generating event streams. The first may be coming over ultra narrow band (UNB. 902-928 Mhz) and formatted in Celsius and metric units, the second may be transmitted over Wi-Fi and in Fahrenheit, and the third may be in Kelvin (K) and transmitted over Bluetooth Low Energy. Each of the data streams may be mapped to a standard “IoMsg_Temp” format that takes into account the network of origin, protocol, time, sensor attributes (type, battery, range, GPS location of sensor etc.), data, and metadata, etc. Once the mapping has been completed, the event streams may then be processed. Possibilities include calculating the average temperature across the streams, correlating by time or GPS location, comparison to emergency thresholds for issuing alerts, applying relevant algorithms, and detecting patterns based on policies.

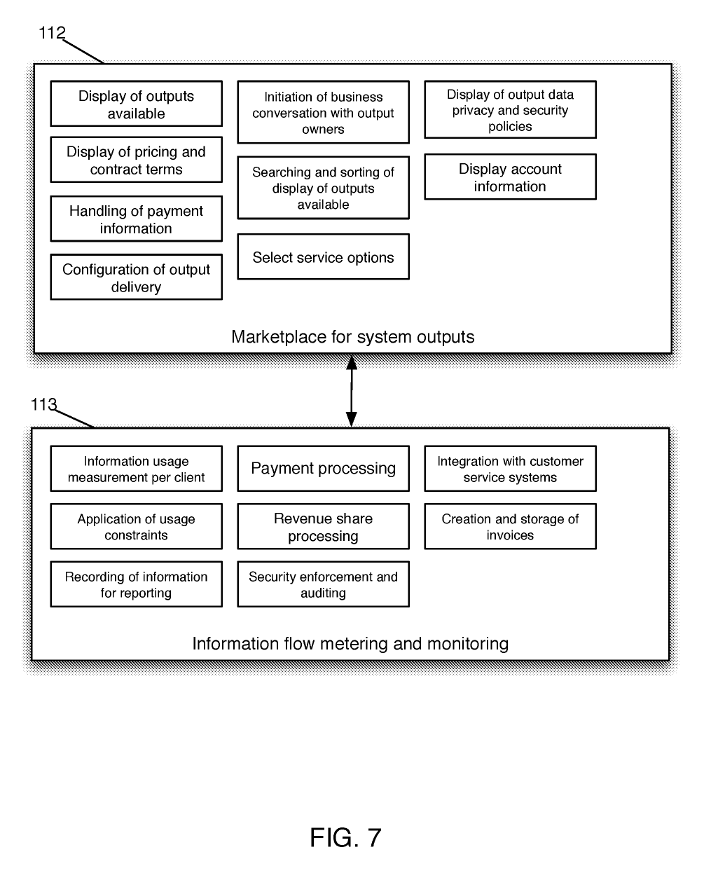

The embodiment may allow not only the mapping, merging, and processing of the different event streams, but also making the event streams available in their standardized format or in a processed state to other functional components or to the world outside of the embodiment [FIG. 1, item 112 and FIG. 7, item 112].

The standard message format may be a wrapper for information content. The structure of the format may be such that any type of information can be contained therein, and the descriptive information needed to understand its contents may be placed in the same location for any type of content. There may be, therefore, a variety of message variations that represent the different types of information being stored and transmitted in the messages. These variations might be understood as a collection of templates or definitions or types that allow users, component builders, or the public to understand which structure to use. The variations may be stored in a repository that can be updated as needed [FIG. 6, item 110].

One purpose of the standard message format is to facilitate interoperability across components and with external elements. By having each component wrap its information in the standard message format, every other component may be able to receive that information and operate upon it as it sees fit. While interoperability is still possible without a standard message format, it is very likely to involve custom engineering work to accomplish. With a greater number of components, that custom effort grows. A component may make itself connectable in the embodiment by specifying which message variations it is able to process as input and which message variations it produces as output.

The standard message format may also allow for sub-variations within a given variation. If the specified information type message variation is temperature, then the sub-variations within that main variation may handle the different temperature measurement scales, the different data encoding possibilities, and any relevant alternatives needed to form a complete body of formats usable for temperature information.

The standard message formats may be made available for public viewing, in order to facilitate software development, design, and component construction. Public discussion of the formats and participation in their creation and improvement may also be allowed.

The body contents (the actual information being wrapped in the message) may be embedded into a section of the message set aside for that purpose. The contents can be in any format and can be of any size. The calculated size may be included outside of the contents section in order to facilitate rapid assessment of the message size. Information related to security, priority, and streaming (message sequencing) may be included in special header sections of the message format. These sections may be flexible to allow for a variety of circumstances. A bitmask field may also be used to allow components to add signatures, mark actions complete, add security levels, and more. Using this field, components further down the processing chain can be instructed to ignore message with certain bits activated. This may streamline the separation and sorting of messages within a component.

An additional field for tagging may also be included. This field can contain any type of information, and can be used differently from one implementation of the embodiment to the next. By adding information to the tagging field, ad-hoc methods of searching, sorting, and processing can be implemented. Also, the tagging field can be used to carry origin information from when the initial information is generated, if there is a need to reveal this information at different stages of processing within or outside of the embodiment.

Several fields for authentication information may also be provided in the message format. Once authentication is successful, some form of identity might be associated with further interactions and transmissions. Otherwise full authentication might take place with each interaction. One method of making authentication durable is to create session tokens upon successful authentication. The tokens may be given a certain lifetime in order to limit the size and scope of security attacks. Passing the token within the provided authentication field may allow all components to retrieve the token easily and perform their own validation without needing to process a full authentication request.

Applications in general and IoT in particular might involve an entire value chain of participants to create, install, manage, and maintain them. One embodiment of the invention may extend the ability of applications running in containers to provide participatory capabilities, where each role in the application lifecycle is granted access to their portion of the lifecycle, and is therefore able to securely collaborate with others' parts of the application. By allowing for numerous parties to focus on the portion of solution development in which they excel, better full-scale solutions may be created. The embodiment may make it dramatically easier for these parties to participate in the development process because they need only focus on working with the embodiment's standards and not the particulars of a specific full-scale solution.

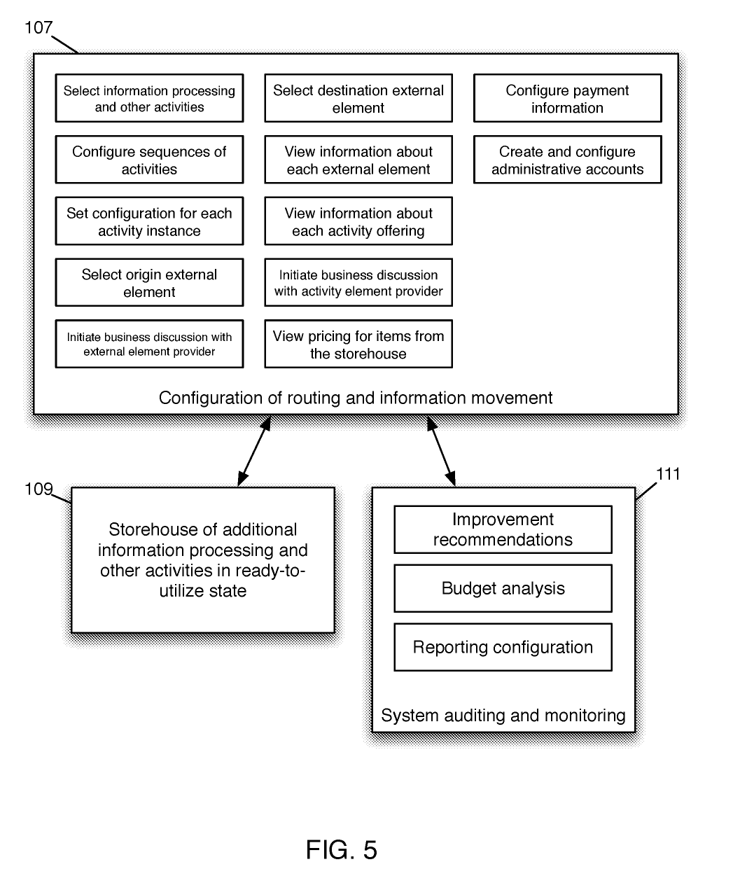

Application pieces may be added, reconfigured, replaced, and removed as needed [FIG. 6, item 109 and FIG. 5, item 109]. The embodiment may improve solution lifecycle management for the owner by serving as a platform on which all specific pieces operate. New solutions may become available over time, but the solution owner might not need to abandon the existing platform to take advantage of them. Vendor lock-in due to technological restrictions may be eliminated in many cases and the risk of beginning solution development immediately may be dramatically reduced. While better components may likely become available in the future, the opportunity to make use of them may not be lost by choosing other components in the immediate timeframe.

For vendors and component builders, new market opportunities may become open because of the embodiment. While a particular vendor may have only a partial solution for some set of customers when standing alone, they may participate in a complete solution by using the embodiment.

One embodiment of the invention may allow for the ability to modify streams of information by adding pieces of code to streams of numeric, audio, and video data that influence the output of the stream. This, in concept, is similar to the ability to apply different optical filters to a professional camera. Similarly, the embodiment may allow users to apply different algorithms to a video stream, such as motion detection, facial recognition, parking detection, etc.

IoT vendors, developers, or enterprise IT and developers may find these code segments by browsing or searching a store [FIG. 5, item 109 and FIG. 6, item 109]. The embodiment may automatically filter and present the specific items that are compatible with the type of data stream being worked on.

The embodiment may provide the ability to dynamically see the impact of the algorithm on the event stream directly and in real-time rather than just as a simulation. The result is that the elements may be inserted or replaced (hot swapped) as the embodiment continues to function and reduces overall maintenance time. The embodiment may allow for multiple algorithms to work on a single data stream. The stream may be allowed to be branched into different pipelines, with different algorithms applied to each of those pipelines.

It may be possible for the creators of the store items to set their own pricing, contract terms, volume limits, and so on [FIG. 6, item 109]. In this way, competitive market forces may help ensure a fair ecosystem. It also may ensure that item creators are free to generate any amount of value through their work because no specific pricing or contract constraints apply. The embodiment may collect and process payment information on behalf of the item vendors. The vendors may share revenue with the embodiment directly by having it apportioned during the payment collection process. Business connections may be made between users and item vendors through the store or other parts of the embodiment. Vendors may have the ability to set pricing in terms of information usage, functionality uptime, or other parameters. To make this possible, information flow metering might be present at points in the embodiment [FIG. 4, item 113].

The items available in the store may be kept in a ready-to-use state that allows for immediate implementation [FIG. 5, item 109 and FIG. 6, item 109]. Implementation may take place at any processing location offered by the embodiment, including at the edge, in the cloud, or in the network operations center (NOC). Because each item, when implemented, may be a separate instance, configuration may be performed on a per-instance basis.

For an item creator or vendor to make their items available in the store, the item may be prepared according to certain requirements. The inclusion of communication handling libraries, software agents, or other mechanisms for interfacing with the rest of the embodiment may be required. The item might also be packaged in a way that it can be replicated and deployed to different points in the embodiment automatically. The store may show all relevant information about each item, so preparation may also include definition of attributes such as network connectivity requirements, protocols spoken, input and output message formats, etc.

Some items may be associated with particular hardware or other external elements. For these items, the software may still be deployed automatically to the chosen processing location. Any hardware installations might involve the need to be performed physically, of course. The embodiment may assist in arranging for such installation efforts to be completed.

The embodiment may empower any sensor owner (consumer, student, civic body, NGO, business, or enterprise, etc.) to publish their sensor streams through the embodiment and make them available via a data stream marketplace for prospective customers of the synthesized knowledge, events, insights, or even the raw data from the sensors. The embodiment may stream, store, manage, and meter the data streams on behalf of the owner of the sensor data. The embodiment may integrate with a billing and payment systems for the payments for a one-time purchase of sensor data or subscriptions to data streams. Additionally, owners of any information stream within the embodiment may make that stream available in the marketplace [FIG. 1, item 112 and FIG. 7, item 112].

The owner of a stream may provide his security and privacy policy information so that it can be displayed to potential stream purchasers. If the stream owner chooses, stream access can be withheld from a purchaser until a customer evaluation has been satisfactorily completed. Such an evaluation may include background checks for employees of the customer organization, ensuring the purchaser has the desired insurance in place, or any other evaluation that would help the stream owner separate desirable customers from undesirable customers or help enforce the stream owner's security and privacy policies.

It may be possible for stream owners to set their own pricing, contract terms, volume limits, and so on. The embodiment may collect and process payment information on behalf of the stream owners. The stream owners may share revenue with the embodiment directly by having it apportioned during the payment collection process. Business connections may be made between potential purchasers and stream owners through the marketplace. Stream owners may have the ability to set pricing in terms of information volume, stream uptime, or other parameters. To make this possible, information flow metering may be present at points in the embodiment. Purchasers who may no longer have access to a stream, because they have consumed their information volume limit or for any other reason, can be automatically prevented from accessing the stream any longer. This may relieve the stream owner of the burden of constant customer monitoring. The stream owner may use the embodiment to generate and access reports regarding purchasers, usage, revenue, revenue sharing with the embodiment, and any other information related to their stream offering in the marketplace.

Potential purchasers may be able to see a display of available streams in the marketplace, along with all of the relevant information for each stream, such as pricing, contract terms, availability, information details, and so on. Potential purchasers may be able to search and sort within the full set of available streams to make finding an appropriate stream easier.

Once a purchaser has purchased access to a stream, he may be able to configure the delivery of the stream information. This may include making use of output adaptors, such as an adaptor for the Salesforce Force.com platform, and the configuration of those adaptors to map the stream output to the purchaser's system in a useful way. The purchaser may also be able to configure the stream to deliver raw data, deliver data to any system via common methodologies such as FTP or HTTP or Web Services, and any other useful method of moving information from the stream to the purchaser's chosen destination. Additionally, the purchaser may be able to choose storage options, bulk output options, and other options that allow the purchaser to customize the stream access.

The embodiment may also provide the ability to push the information either to its own cloud or to a partner cloud service or enterprise backend systems. The embodiment may provide adapters that manage both the secure connection and the transmission of data to the relevant external-system. For instance, an adaptor for Salesforce would securely connect and map the sensor data to the data/object model of a Salesforce Standard Object. The connection with other external enterprise systems may be managed in a similar manner. This includes the full range of infrastructure as a service (IaaS) and platform as a service (PaaS) providers: AWS/Kinesis, Openstack, Cloudstack, IBM MQ series, Oracle messaging server/complex event processing, etc. [FIG. 1, items 101.c and 101.d and 102 and FIG. 2, items 101.c and 101.d and 102].

The embodiment may send information to a cloud, partner cloud service, or external enterprise backend system at any point in the information flow. This does not need to interrupt the flow of information, which may continue onward to its next destination if it has been configured in this manner.

Any person or entity may be able to develop backend adaptors to be used in the embodiment. Some ready-made adaptors may be available to users of the embodiment through the store. Adaptors may be built on an as-needed basis, as well, by any party. All adaptors offered through the store may be required meet quality standards, regardless of the developing entity. Guidelines, development kits, code samples, instructions, and other offerings may be viewed or downloaded by persons or entities interested in providing adaptors or other offerings through the store.

The same cloud, partner cloud service, or enterprise backend choices described here may also be made available to any person or entity who purchases access to a stream through the marketplace.

The embodiment can be packaged in a variety of configurations. For example, as an appliance that can be installed on the ‘edge’ of the network as part of a computing/network rack or as a standalone unit. This may be the default configuration of the embodiment, and might make setup and integration simple and convenient in a range of environments including buildings, industrial sites, city blocks, etc. All of the sensors in the environment may connect directly to the appliance in this configuration over a range of protocols and networks [FIG. 1, items 101.a and 101.b and 102 and FIG. 2, items 101.a and 101.b and 102].

Another configuration is as an installation of software and hardware onto the existing network infrastructure of an enterprise, where the Information Technology employees (IT) can choose to configure the software on their own edge servers, integrate with their own network switch, and install the required IoT networks including: Wi-Fi, ultra narrow band wireless networking, legacy machine to machine (M2M), industrial scientific and manufacturing (ISM), and RFID gateways. The Enterprise can also choose to place the servers not just on the edge but also in their network operating centers (NOC) and integrate remotely with remote sensors and devices over protocols and networks of their choosing. It is anticipated that enterprises may choose to have a ‘hybrid’ or a ‘mix’ of edge and centralized configuration of the embodiment. A management console of the installed software may be integrated into the enterprise management console platform. Similarly, the billing and analytics may be integrated into the respective enterprise-systems.

It is envisioned that the software might be installed by telecommunications, cable, operators, or cloud operators who deliver computing power broadly but may want to deliver the highest performance locally. To accomplish this they can install the embodiment locally, regionally, or in their own main central servers. IoT sensor streams can be connected and processed locally, regionally, or at the backend-systems. It is predicted that as the volume of data increases exponentially, more and more load balancing may be pushed to the edge of the network. A software management function of the embodiment would integrate with the billing (BSS), service (QOS), and other external-systems.

The embodiment in the form of software may also be installed in high capacity edge devices (herein referred to as “super sensors” and/or “gateways”) that can detect, collect and connect with other sensors and process the information streams. These super sensors or gateways might involve their own processing, networking, and other capabilities. This configuration may also include portable edge devices, including smartphones and security cameras where all or some of the processing is done on the edge device and these devices become the hub for all sensors in their proximity. In this situation, the event or message streams may be periodically synched with remote servers if real-time delivery is not optimal or feasible.

Amongst other configurations for the home and small business is a configuration wherein the embodiment is placed on powered hardware USB dongles that have local processing power, memory, and network connections and can also push event processing to remote servers. The embodiment may also be licensed for integration with other IoT processing servers and external-systems.

For configuration options that include network configuration and control, the embodiment may be able to interface with network hardware and software in order to perform operations and exert control as needed. When the invention is embodied in a specialized physical device, such as a rack-mountable computing unit, the embodiment can be configured for the network switch hardware included in the specialized appliance unit. The embodiment can also be configured to interact with different routers and switches from Cisco, Juniper, Palo Alto Networks, or any virtual network including those from VMWare or other providers. The embodiment may interface with any computer network management and configuration tool or toolset that is available to be controlled via plugin.

No matter which configuration types are chosen, the embodiment may be deployed at the network edge, within existing networks, and in the cloud simultaneously. Multiple deployment points are not only possible, but having deployments of the embodiment in several locations allows for the different embodiment instances to work together as a mesh network and form a larger, more capable super embodiment.

The embodiment may also be extended with “blade box” units that accept partner vendor hardware networking, storage, or processing cards. The blade box units may integrate seamlessly with other hardware. Blade boxes are not required for external element integration but in many cases they might provide enhanced security, installation speed, ease of configuration, and other benefits.

Not all users of the embodiment may want to perform hardware installations directly. Access to specific elements or sections of the embodiment may be granted to third parties in order to perform installation, configuration, troubleshooting, or maintenance. The access can be revoked when the services have been performed. Each vendor registered in the embodiment may be allowed to manage their own segment, making it easier to service, manage, and support the overall embodiment.

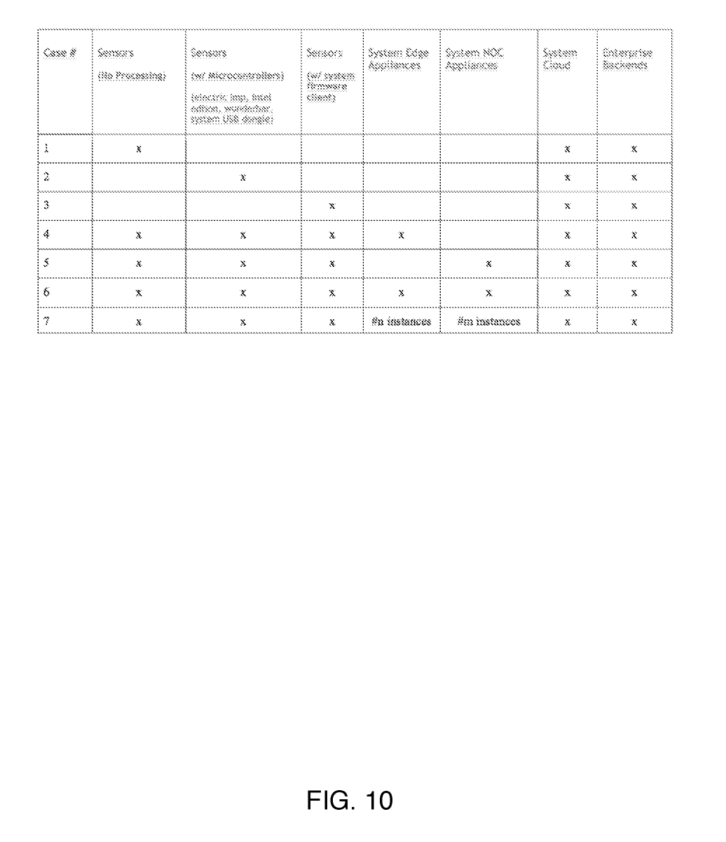

To better illustrate the variety of deployment and distribution options, a configuration table has been provided [FIG. 10]. The different functional components of the invention can be deployed in a distributed/meshed manner across the different processing points described in the columns of the table. For example, an edge dongle or edge appliance deployment of the embodiment can manage only the sensor connection and the conversion of sensor data to a standard-message and then the rest of the processing can be done on a compatible appliance in a rack in a data center or NOC. The reverse can also be true. To create a distributed network that brokers IoT streams, the different edge dongles, edge appliances, data center processing devices, and the cloud can perform any of the functions of the embodiment including, but not limited to: connecting to raw sensor streams, normalizing sensor data into tracks, applying elements to process the data streams, integrating with enterprise data, creating composite streams of data by merging different event streams, and applying policies and rules.

The embodiment may make processing information on the network edge much easier. Through its unique data routing capability, external elements may connect into the embodiment through a variety of network connectivity options. Once connected, the data may flow to virtualized processing instances that can interface with the data and the external elements using any of a variety of languages, frameworks, development platforms, etc. With this level of compatibility, the challenges of incorporating edge processing into a solution may move from being a hardware and software challenge to being only a software challenge.

Through information flow monitoring and reporting, the value of the edge processing may be shown to the user directly [FIG. 5, item 111 and FIG. 7, item 113]. Large quantities of information processed at the edge do not need to consume bandwidth, storage, and processing resources further into the network or in the cloud. The differential may be displayed by the user to assess the effectiveness of the edge processing or support decision-making regarding further edge deployments.

Provided that the embodiment has been deployed both at the edge and in the cloud, each processing instance in the embodiment may be configured to run in the preferred location (edge or cloud). Some processing may require a greater amount of computing power, for example, and would be more efficiently operated in the cloud. While the greater volume of information is likely to exist at the edge, an aggregate version of the information may be valuable in the cloud. Moving streams of aggregated information from the edge to the cloud might allow for further aggregation with minimal bandwidth consumption. Because security credentials and other sensitive information may be required for connectivity to external elements, conducting those operations in the cloud or from a secure data center may be a beneficial choice.

The embodiment may allow for information to be routed and moved to and from as many points as desired [FIG. 1, items 105, 106.a, 106.b, 106.c, 106.d, 106.e, and 106.f and FIG. 3, items 105 and 107 and FIG. 4, items 105, 106.c, 106.e and Figure #5, item 107]. Ultimately, a user may configure information to arrive at some final set of points. Taking the information origin and destination points as the endpoints, the whole set of operations may form a sequence called a “track”. A track may be a chain of processing destinations that allows for end-to-end planning of information flows. Information may be moved or routed between different tracks. That allows a copy of an information stream to be branched out from one track and into another, possibly increasing the processing options that can take place simultaneously. Several tracks may also be merged into one track for simplicity or as a way of reducing the number of information streams moving from the edge to the cloud, for example.

The creation of a track may simply be a matter of selecting information inputs, selecting processing elements, selecting information outputs, and putting all of these selections into the desired sequence. One embodiment of the invention allows the different points on a track to be items from the store, custom-built items, or standard items included with the embodiment [FIG. 5, items 107 and 109 and FIG. 6, item 109]. Users may be able to initiate a request for custom item development services or for a specific item to be made available. If the user has purchased access to information streams from the marketplace, those streams may be integrated into any tracks belonging to that user.

The time clock of different sensors (and the associated time stamp on the data streams) may differ. The difference increments could be from negligible nanoseconds or milliseconds to several seconds or even minutes in some extreme cases. The embodiment may have an internal clock, which represents the ‘base time’. The embodiment may record and store the differential from this base time and the timestamp of the sensor and its related data stream. It may maintain this differential for all sensor data, data streams, and composite information streams and tracks [FIG. 1, item 103 and FIG. 2, item 103].

In situations where it is not possible to reset the time clock on the sensor or external device, the embodiment may ask each sensor or sensor stream to provide all events that fall within the differential range (as determined by comparing the sensor time to the base time) so that correlations can be inferred from the streams even though the clocks differ in their time stamp. For example, after an accident or public safety incident, all of the sensors may be asked to report all events within the time differential and then an analyst or analytics engine can draw meaningful correlations from the information reported.

Time hot-spot functionality may allow the user/administrator of the embodiment to set time durations that are higher priority than others and where the components can increase the frequency, resolution, or other information parameters to gather more fine-grained information from a select set of sensors or from all of the sensors. The time hot-spot may also be set for a physical space such as a door, a window, a gate, or a geo-position. Different time hot-spots may be assigned to different physical spaces. The data streams, events, and tracks associated with the time hot-spots may be managed with higher priority, which means they may be kept in memory longer, may be assigned to specific virtualized processes, or may be handled in other ways required to effect more detailed output.

What is claimed is:

1. A method for processing information, comprising:
supplying one or more connectors for coupling with external elements;
supplying one or more message canonicalizers having an interface with a said connector;
supplying a track, which is an information structure and an associated information store that parallels the information structure;
supplying one or more processing elements and means for coupling said processing elements to the track information structure.

2. An computer system, comprising:
one or more connectors to external elements;
one or more message canonicalizers;
a track, which is an information structure and an associated information store that parallels the information structure;
one or more processing elements that are mapped to the track information structure.

3. A computer system of claim 2, where at least one connector is coupled with one or more message de-canonicalizers.

4. A computer system of claim 2, where at least one processing element is coupled with one or more message de-canonicalizers.

5. A method for track configuration, comprising:
a means for defining the information structure of a track;
supplying an inventory of available processing elements;
a means for mapping processing elements to the information structure of the track.

6. A computer system for track configuration, comprising:
a structure of information stored in the track;
an inventory of deployed processing elements;
a map associating processing elements with the information structure of the track.
